(19) United States
(12) Patent Application Publication
(10) Pub. No.: US 2020/0310209 A1
(43) Pub. Date: Oct. 1, 2020

(54) DISPLAY DEVICE

(71) Applicant: Japan Display Inc., Minato-ku (JP)

(72) Inventors: Kentaro OKUYAMA, Tokyo (JP); Hiroki SUGIYAMA, Tokyo (JP); Yoshihide OHUE, Tokyo (JP)

(73) Assignee: Japan Display Inc., Minato-ku (JP)

(21) Appl. No.: 16/829,031

(22) Filed: Mar. 25, 2020

(30) Foreign Application Priority Data
Mar. 27, 2019 (JP) 2019-060676

(51) Int. Cl. G02F 1/1362; G02F 1/1339; G02F 1/1334

(52) U.S. Cl. CPC G02F 1/136286; G02F 1/1334; G02F 1/13394

(57) ABSTRACT

According to one embodiment, a display device including a first substrate a pixel electrode, and lines, a second substrate including a common electrode, a liquid crystal layer located between the first substrate and the second substrate, and a sealing material located in a non-display area, wherein each of the lines includes a first portion extending in a first direction in a display area and a second portion extending in a second direction in the non-display area, the lines include first lines, the second portion of each of the first lines overlapping the sealing material, and the common electrode does not overlap the second portion in an area overlapping the liquid crystal layer.

### CROSS-REFERENCE TO RELATED APPLICATIONS

This application is based upon and claims the benefit of priority from Japanese Patent Application No. 2019-060676, filed Mar. 27, 2019, the entire contents of which are incorporated herein by reference.

### FIELD

Embodiments described herein relate generally to a display device.

### BACKGROUND

In recent years, display devices in various forms have been proposed. An illumination device comprising a light modulating layer including a bulk and fine particles having optical anisotropy in a light modulating element bonded to a light guide has been disclosed. As another example, a light source device including a polymer-dispersed liquid crystal layer and comprising a light conversion portion which converts the intensity of incident light has been disclosed.

### BRIEF DESCRIPTION OF THE DRAWINGS

FIG. 1 is a plan view showing a structure example of a display device of a first embodiment.

FIG. 2 is a perspective view showing the main parts of the display device shown in FIG. 1.

FIG. 3 is an enlarged plan view showing a structure example of a switching element in a pixel shown in FIG. 1.

FIG. 4 is a cross-sectional view showing a structure example of a display area of a display panel shown in FIG. 1.

FIG. 5 is a plan view schematically showing a structure example of a first substrate according to the first embodiment.

FIG. 6 is a cross-sectional view of the display panel along line A-A shown in FIG. 5.

FIG. 7 is a plan view showing a structure example of the display panel shown in FIG. 6.

FIG. 8 is a plan view schematically showing a structure example of a display panel according to a second embodiment.

FIG. 9 is a cross-sectional view of the display panel along line A-A shown in FIG. 8.

FIG. 10 is a cross-sectional view of the display panel along line B-B shown in FIG. 8.

FIG. 11 is a cross-sectional view of the display panel along line A-A shown in FIG. 5.

### DETAILED DESCRIPTION

In general, according to one embodiment, a display device comprising: a first substrate comprising a first insulating substrate, a pixel electrode located in a display area, and lines located in the display area and a non-display area surrounding the display area; a second substrate comprising a second insulating substrate and a common electrode overlapping the pixel electrode; a liquid crystal layer located between the first substrate and the second substrate; and a sealing material located in the non-display area, the first substrate and the second substrate being bonded to each other with the sealing material, wherein each of the lines comprises a first portion extending in a first direction in the display area and a second portion extending in a second direction crossing the first direction in the non-display area, the lines include first lines, the second portion of each of the first lines overlapping the sealing material, and the common electrode does not overlap the second portion in an area overlapping the liquid crystal layer.

According to another embodiment, a display device comprising: a display area configured to display an image; a non-display area surrounding the display area; a first substrate with a first transparent substrate and lines located in the display area and the non-display area; a second substrate with a second transparent substrate and a common electrode located in at least the display area; a liquid crystal layer located between the first substrate and the second substrate and including polymers in a shape of stripes and liquid crystal molecules; a sealing material located in the non-display area, the first substrate and the second substrate being bonded to each other with the sealing material; and a light-emitting element opposed to a side surface of the second transparent substrate and emitting light toward the side surface, wherein each of the lines includes a first portion extending in a first direction in the display area and a second portion extending in a second direction crossing the first direction in the non-display area, the lines include first lines, the second portion of each of the first lines overlapping the sealing material, and the common electrode does not overlap the second portion in an area overlapping the liquid crystal layer.

Embodiments will be described hereinafter with reference to the drawings. The disclosure is merely an example, and proper changes within the spirit of the invention which are easily conceivable by a person having ordinary skill in the art are included in the scope of the present invention as a matter of course. In addition, in order to make the description clearer, the width, thickness, shape, etc., of each portion may be schematically shown in the drawings as compared to those in reality, but they are merely examples and do not limit the interpretation of the present invention. Furthermore, in the specification and each of the as or a similar function to those already described with reference to a preceding figure will be given the same reference numerals, and overlapping detailed descriptions may be omitted as appropriate.

### First Embodiment

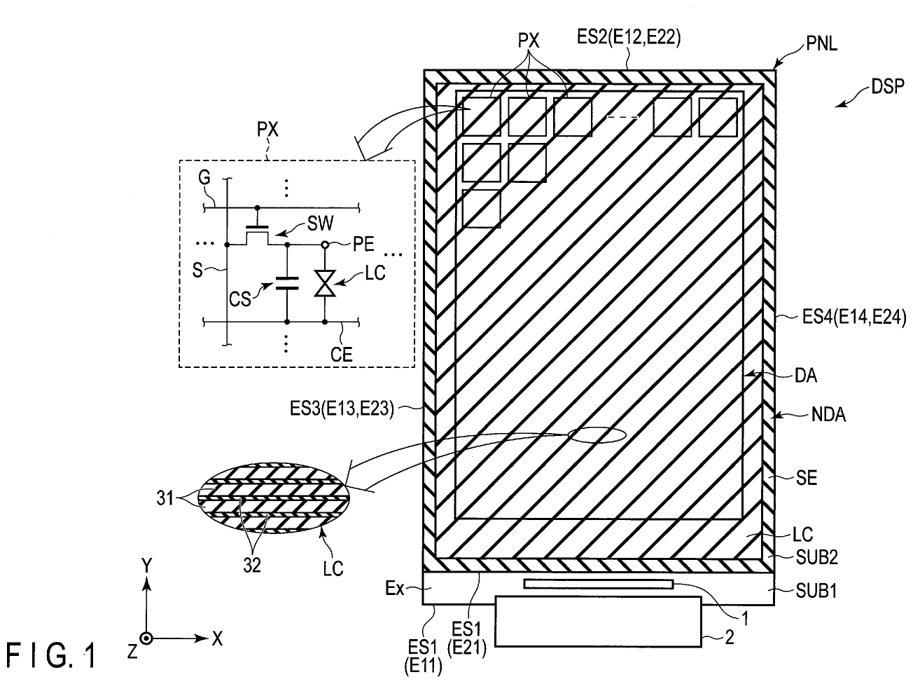

FIG. 1 is a plan view showing a structure example of a display device DSP of a first embodiment. In an example, a first direction X, a second direction Y, and a third direction Z are orthogonal to each other, but may cross at an angle other than 90 degrees. The first direction X and the second direction Y correspond to directions parallel to a main surface of a substrate constituting the display device DSP, and the third direction Z corresponds to a thickness direction of the display device DSP. In the present specification, a direction from a first substrate SUB1 to a second substrate SUB2 is referred to as an “upward” direction (or simply “above”), and a direction from the second substrate SUB2 to the first substrate SUB1 is referred to as a “downward” direction (or simply “below”). Expressions such as “a second member above a first member” and “a second member below a first member” mean that the second member may be in contact with the first member or separate from the first member. In addition, it is assumed that an observation position from which the display device DSP is observed is on the tip side of the arrow indicating the third direction Z, and the view from the observation position toward an X-Y plane defined by the first direction X and the second direction Y is referred to as planar view.

In the present embodiment, a liquid crystal display device in which polymer-dispersed liquid crystals are employed will be described as an example of the display device DSP. The display device DSP comprises a display panel PNL, an IC chip 1, and a wiring board 2.

The display panel PNL comprises the first substrate SUB1, the second substrate SUB2, a liquid crystal layer LC, and a sealing material SE. The first substrate SUB1 and the second substrate SUB2 are formed in the shape of a flat plate parallel to the X-Y plane. The first substrate SUB1 and the second substrate SUB2 overlap in planar view. The first substrate SUB1 and the second substrate SUB2 are bonded to each other with the sealing material SE. The liquid crystal layer LC is held between the first substrate SUB1 and the second substrate SUB2, and is sealed in with the sealing material SE. In FIG. 1, the liquid crystal layer LC and the sealing material SE are indicated by different diagonal lines.

As enlargedly and schematically shown in FIG. 1, the liquid crystal layer LC comprises polymer-dispersed liquid crystals including polymers 31 and liquid crystal molecules 32. In an example, the polymers 31 are liquid crystal polymers. The polymers 31 are formed in the shape of stripes extending in the first direction X. The liquid crystal molecules 32 are dispersed in the gaps between the polymers 31, and aligned so that their major axes extend in the first direction X. Each of the polymers 31 and the liquid crystal molecules 32 has optical anisotropy or refractive anisotropy. The responsiveness to an electric field of the polymers 31 is lower than that of the liquid crystal molecules 32.

In an example, the alignment direction of the polymers 31 hardly varies regardless of the presence or absence of an electric field. In contrast, the alignment direction of the liquid crystal molecules 32 varies according to an electric field in a state in which a high voltage higher than or equal to a threshold value is applied to the liquid crystal layer LC. In a state in which the voltage is not applied to the liquid crystal layer LC, the respective optical axes of the polymers 31 and the liquid crystal molecules 32 are parallel to each other, and light incident on the liquid crystal layer LC is hardly scattered in the liquid crystal layer LC and is transmitted (transparent state). In a state in which the voltage is applied to the liquid crystal layer LC, the respective optical axes of the polymers 31 and the liquid crystal molecules 32 cross each other, and light incident on the liquid crystal layer LC is scattered in the liquid crystal layer LC (scattered state).

The display panel PNL comprises a display area DA where an image is displayed and a non-display area NDA in the shape of a frame surrounding the display area DA. The display area DA comprises pixels PX arranged in a matrix in the first direction X and the second direction Y. The sealing material SE is located in the non-display area NDA, and is disposed to surround the perimeter of the display area DA.

As enlargedly shown in FIG. 1, scanning lines G each extend in the first direction X, and are arranged at intervals in the second direction Y. Signal lines S each extend in the second direction Y, and are arranged at intervals in the first direction X. Each of the pixels PX corresponds to an area defined by two signal lines S successively arranged in the first direction X and two scanning lines G successively arranged in the second direction Y. Each of the pixels PX comprises a switching element SW, a pixel electrode PE, a common electrode CE, the liquid crystal layer LC, etc. The switching element SW is disposed at the intersection of the scanning line G and the signal line S. The switching element SW is made of, for example, a thin-film transistor (TFT), and is electrically connected to the scanning line G and the signal line S. The switching elements SW arranged in the first direction X are each electrically connected to the scanning line G. The switching elements SW arranged in the second direction Y are each electrically connected to the signal line S. The pixel electrodes PE are electrically connected to the switching elements SW. Each of the pixel electrodes PE is opposed to the common electrode CE, and drives the liquid crystal layer LC (especially, the liquid crystal molecules 32) by an electric field produced between the pixel electrodes PE and the common electrode CE. Capacitance CS is, for example, formed between an electrode equal in potential to the common electrode CE and an electrode equal in potential to the pixel electrodes PE.

More specifically, the scanning line G to which a gate signal is input is first selected from the scanning lines G, and an image signal is input to the switching elements SW connected to the selected scanning line G via the signal lines S. A potential is thereby applied to the pixel electrodes PE, and an electric field is produced between the pixel electrodes PE and the common electrode CE. Since the liquid crystal layer LC is driven by the electric field produced between the pixel electrodes PE and the common electrode CE, the scanning lines G and the signal lines S are considered to be lines for driving liquid crystals.

The display panel PNL comprises an edge portion (hereinafter, also referred to as an end portion or a side surface) ES1 extending in the first direction X, an edge portion ES2 on the opposite side to the edge portion ES1 in the second direction Y, an edge portion ES3 extending in the second direction Y, and an edge portion ES4 on the opposite side to the edge portion ES3 in the first direction X. The edge portions ES1 and ES2 each cross the edge portions ES3 and ES4.

The first substrate SUB1 comprises an edge portion E11 extending in the first direction X, an edge portion E12 on the opposite side to the edge portion E11 in the second direction Y, an edge portion E13 extending in the second direction Y, and an edge portion E14 on the opposite side to the edge portion E13 in the first direction X. The edge portions E11 and E12 each cross the edge portions 513 and E14. The second substrate SUB2 comprises an edge portion E21 extending in the first direction X, an edge portion E22 on the opposite side to the edge portion E21 in the second direction Y, an edge portion E23 extending in the second direction Y, and an edge portion E24 on the opposite side to the edge portion E23 in the first direction X. The edge portions E21 and E22 each cross the edge portions E23 and E24.

In the example shown in FIG. 1, the edge portions E12 and E22 overlap in planar view. The edge portions E12 and E22 correspond to the edge portion ES2. The edge portions E12 and E22 may not overlap. In addition, any one of the edge portions E12 and E22 may correspond to the edge portion ES2. In planar view, the edge portions E13 and E23 overlap. The edge portions E13 and E23 correspond to the edge portion ES3. The edge portions E13 and E23 may not overlap. In addition, any one of the edge portions El3 and E23 may correspond to the edge portion ES3. In planar view, the edge portions E14 and E24 overlap. The edge portions E14 and E24 correspond to the edge portion ES4. The edge portions E14 and E24 may not overlap. In addition, any one of the edge portions El4 and E24 may correspond to the edge portion ES4. In planar view, the edge portions E11 and E21 are misaligned in the second direction Y. The edge portion E11 is located more outside than the edge portion E21 in the second direction Y. At least one of the edge portions E11 and E21 correspond to the edge portion ES1. The first substrate SUB1 comprises an extension portion Ex located between the edge portion E11 and the edge portion E21.

The IC chip 1 and the wiring board 2 are each connected to the extension portion Ex. The IC chip 1 contains, for example, a display driver which outputs a signal necessary to display an image. The wiring board 2 is a flexible printed circuit. The IC chip 1 may be connected to the wiring board 2. The IC chip 1 and the wiring board 2 may read a signal from the display panel PNL, but mainly function as a signal source which supplies a signal to the display panel PNL.

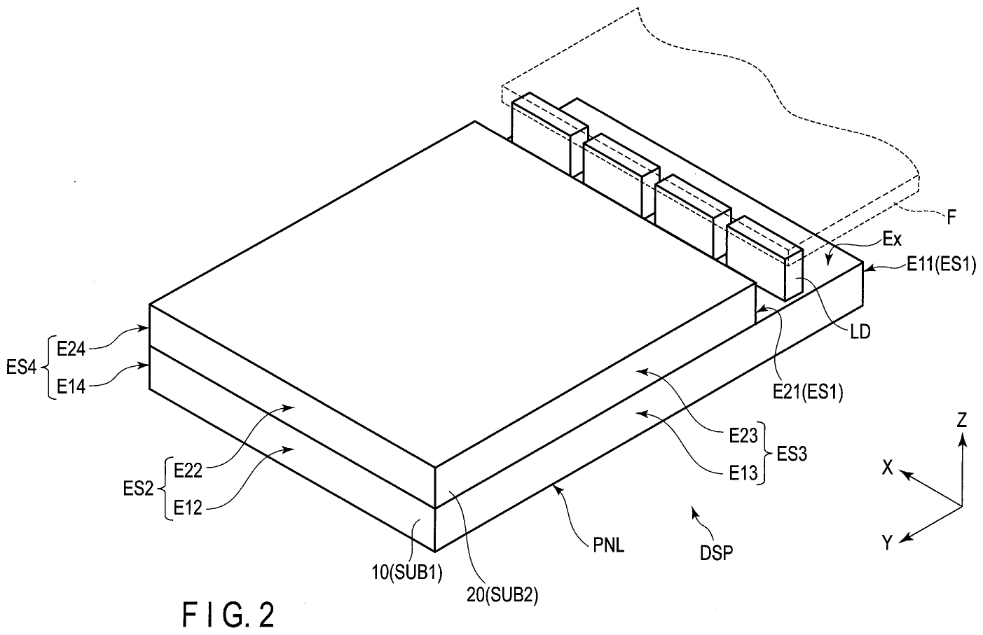

FIG. 2 is a perspective view showing the main parts of the display device DSP shown in FIG. 1.

The display device DSP comprises light-emitting elements LD as well as the display panel PNL.

The first substrate SUB1 and the second substrate SUB2 are opposed to each other. The first substrate SUB1 comprises a transparent substrate 10. The transparent substrate 10 comprises the edge portions E11 to E14. The second substrate SUB2 comprises a transparent substrate 20. The transparent substrate 20 is opposed to the transparent substrate 10, and comprises the edge portions E21 to E24. The light-emitting elements LD are arranged at intervals in the first direction X, and are opposed to the edge portion E21 in the second direction Y. In the shown example, the light-emitting elements LD overlap the extension portion Ex. The light-emitting elements LD are connected to a wiring board F. The light-emitting elements LD are, for example, light-emitting diodes. The light-emitting elements LD comprise a red light-emitting portion, a green light-emitting portion, and a blue light-emitting portion, which will not be described in detail. Light emitted from the light-emitting elements LD travels in the direction of the arrow indicating the second direction Y, and is incident on the transparent substrate 20 from the edge portion E21. The transparent substrates 10 and 20 may be each formed of transparent substrates.

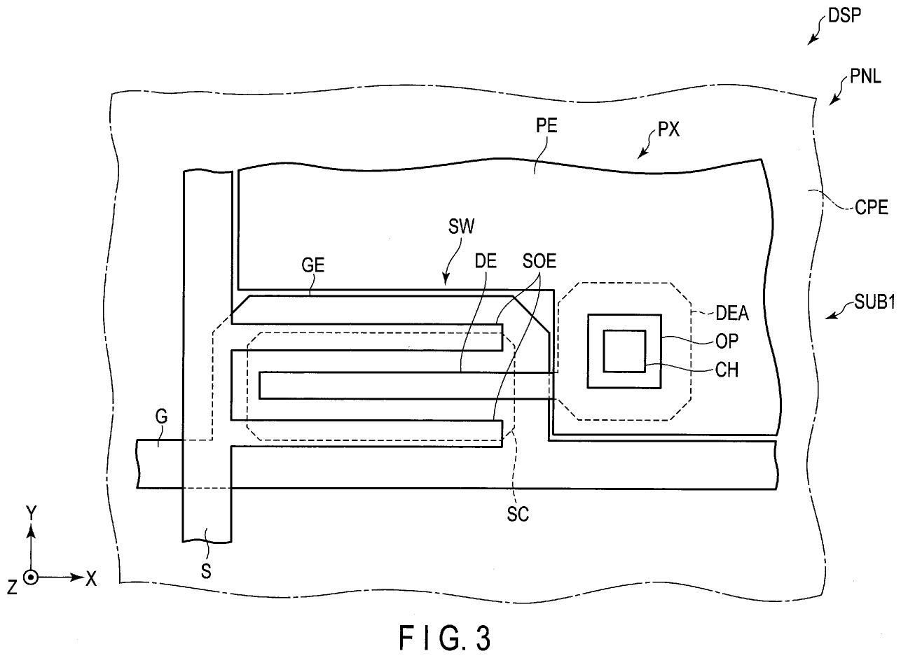

FIG. 3 is an enlarged plan view showing a structure example of the switching element SW in the pixel PX shown in FIG. 1.

The first substrate SUB1 comprises a capacitance electrode CPE, etc. The capacitance electrode CPE is disposed over the pixels PX. For example, the capacitance electrode CPE is disposed over substantially all the area of the first substrate SUB1 in the X-Y plane. In the example shown in FIG. 3, the capacitance electrode CPE overlaps the switching element SW, the scanning line G, and the signal line S. The switching element SW comprises a semiconductor layer SC, a gate electrode GE, source electrodes SOE, and a drain electrode DE. The gate electrode GE is formed integrally with the scanning line G. In other words, the gate electrode GE corresponds to the scanning line G. The semiconductor layer SC overlaps the gate electrode GE. The semiconductor layer SC is electrically connected to the gate electrode GE. The two source electrodes SOE are formed integrally with the signal line S, and are each in contact with the semiconductor layer SC. In other words, the source electrodes SOE correspond to the signal line S, and are electrically connected to the semiconductor layer SC.

The drain electrode DE is located between the two source electrodes SOE, and is in contact with the semiconductor layer SC. In other words, the drain electrode DE is electrically connected to the semiconductor layer SC. The drain electrode DE comprises a connection portion DEA. The connection portion DEA is electrically connected to the pixel electrode PE via an opening portion OP and a contact hole CH formed in the capacitance electrode CPE.

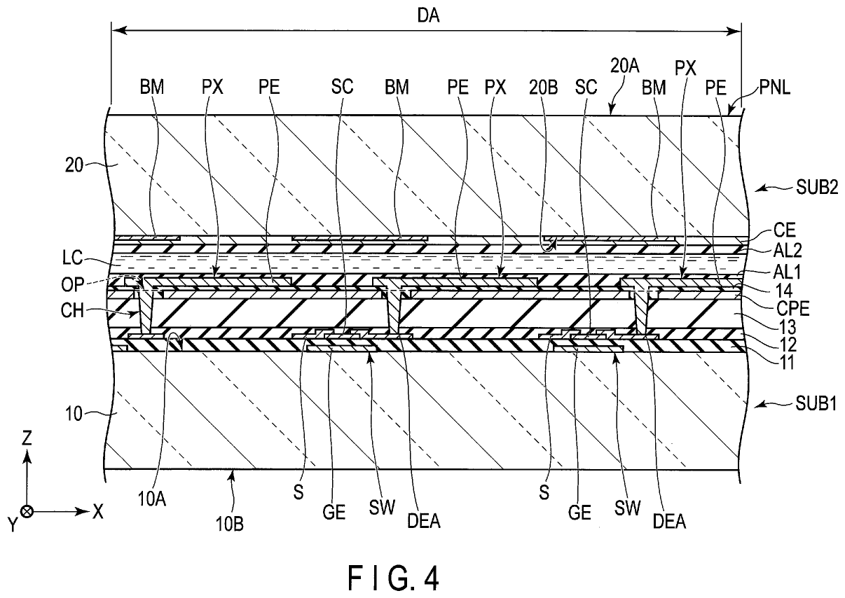

FIG. 4 is a cross-sectional view showing a structure example of the display area DA of the display panel PNL shown in FIG. 1.

The first substrate SUB1 comprises the transparent substrate 10, insulating layers 11, 12, 13, and 14, the capacitance electrode CPE, the signal lines S, the switching elements SW, the pixel electrodes PE, an alignment film AL1, etc. The first substrate SUB1 further comprises the scanning lines G shown in FIG. 1, etc. The transparent substrate 10 comprises a main surface (upper surface) 10A and an opposite surface (lower surface) 10B on the opposite side to the main surface 10A.

The switching elements SW are located on the main surface 10A side. In the example shown in FIG. 4, the gate electrodes GE (scanning lines G) are located on the main surface 10A side of the transparent substrate 10. The insulating layer 11 is located above the transparent substrate 10 and the gate electrodes GE, and covers the transparent substrate 10 and the gate electrodes GE. In other words, the gate electrodes GE are located between the transparent substrate 10 and the insulating layer 11. The semiconductor layers SC are located above the insulating layer 11. The connection portions DEA (drain electrodes DE) are located above the insulating layer 11. In other words, the signal lines S, the semiconductor layers SC, and the drain electrodes DE are located on the main surface 10A side, and are located in the same layer. In the example shown in FIG. 4, the switching elements SW are a bottom-gate type of switching element in which a gate electrode GE is located below a semiconductor layer SC. The switching elements SW may be a top-gate type switching element in which a gate electrode is located above a semiconductor layer SC. The signal lines S are located above the insulating layer 11. In other words, the gate electrodes GE are opposed to the semiconductor layers SC. The insulating layer 12 is located above the insulating layer 11, and covers the signal lines S, the semiconductor layers SC, and the connection portions DEA. In other words, the signal lines S, the semiconductor layers SC, and the connection portions DEA are located between the insulating layer 11 and the insulating layer 12. The insulating layer 13 is located above the insulating layer 12, and covers the insulating layer 12. In other words, the insulating layer 13 is located above the signal lines S, the semiconductor layers SC, and the connection portions DEA.

The capacitance electrode CPE is located above the insulating layer 13. In other words, the insulating layer 13 is located between the capacitance electrode CPE and each of the signal lines S, the semiconductor layers SC, and the connection portions DEA. The capacitance electrode CPE comprises the opening portions OP penetrating the capacitance electrode CPE from the upper surface to the lower surface. The insulating layer 14 covers the capacitance electrode CPE. In the opening portions OP, the insulating layer 14 covers the insulating layer 13. In other words, the capacitance electrode CPE is located above the signal lines S, the semiconductor layers SC, and the connection portions DEA. The pixel electrodes PE are located above the insulating layer 14, and are provided in the pixels PX, respectively. In other words, the pixel electrodes PE are located above the signal lines S, the semiconductor layers SC, the connection portions DEA, and the capacitance electrode CPE. The pixel electrodes PE are electrically connected to the connection portions DEA via the opening portions OP of the capacitance electrode CPE and the contact holes CH penetrating the insulating layers 12 to 14 to the connection portions DEA. In other words, the pixel electrodes PE are electrically connected to the switching elements SW via the opening portions OP and the contact holes CH. The pixel electrodes PE are opposed to the capacitance electrode CPE with the insulating layer 14 interposed therebetween, and forms the capacitance CS of the pixels PX. The alignment film AL1 covers the pixel electrodes PE and the insulating layer 14. The first substrate SUB1 is not limited to the shown example, and may include other insulating layers or other various layers.

The second substrate SUB2 comprises the transparent substrate 20, a light-shielding layer BM, the common electrode CE, an alignment film AL2, etc. The transparent substrate 20 comprises a main surface (upper surface) 20A and an opposite surface (lower surface) 20B on the opposite side to the main surface 20A. The opposite surface 20B of the transparent substrate 20 is opposed to the main surface 10A of the transparent substrate 10. The light-shielding layer BM and the common electrode CE are located on the opposite surface 20B side. In the example shown in FIG. 4, the light-shielding layer BM is located below the transparent substrate 20. The light-shielding layer BM is, for example, located right above the signal lines S and the switching elements SW (semiconductor layers SC, gate electrodes GE, connection portions DEA, etc.). In addition, the light-shielding layer BM is also located right above the scanning lines G not shown in FIG. 4. The common electrode CE is disposed over the pixels PX. The common electrode CE is located below the transparent substrate 20 and the light-shielding layer BM. The common electrode CE, for example, directly covers the light-shielding layer BM. The common electrode CE, for example, covers the transparent substrate 20 in the area other than the area where the common electrode CE covers the light-shielding layer BM. In other words, the light-shielding layer BM is located between the transparent substrate 20 and the common electrode CE. The common electrode CE is electrically connected to the capacitance electrode CPE, and is equal in potential to the capacitance electrode CPE. The alignment film AL2 covers the common electrode CE.

The liquid crystal layer LC is located between the main surface 10A and the opposite surface 208, and is in contact with the alignment films AL1 and AL2. In the first substrate SUB1, the insulating layers 11 to 14, the capacitance electrode CPE, the signal lines S, the switching elements SW (semiconductor layers SC, gate electrodes GE, connection portions DEA, etc.), the pixel electrodes PE, and the alignment film AL1 are located between the main surface 10A and the liquid crystal layer LC. In the second substrate SUB2, the light-shielding layer BM, the common electrode CE, and the alignment film AL2 are located between the opposite surface 20B and the liquid crystal layer LC.

The transparent substrates 10 and 20 are insulating substrates such as glass substrates or plastic substrates. The main surface 10A, the opposite surface 10B, the main surface 20A, and the opposite surface 20B are surfaces substantially parallel to the X-Y plane. The insulating layers 11, 12, and 14 are, for example, formed of a transparent inorganic insulating material such as silicon nitride or silicon oxide. The insulating layer 13 is, for example, formed of a transparent organic insulating material such as acrylic resin. The scanning lines G and the signal lines S are, for example, laminated structures in which conductive layers are stacked. In an example, the scanning lines G and the signal lines S are laminated structures in which a conductive layer including molybdenum (Mo), a conductive layer including aluminum (Al), and a conductive layer including molybdenum (Mo) are stacked in this order. In addition, the scanning lines G and the signal lines S are not limited to the above example, and may be laminated structures in which a conductive layer including titanium (Ti), a conductive layer including aluminum (Al), and a conductive layer including titanium (Ti) are stacked in this order. The scanning lines G may be laminated structures of a conductive layer including molybdenum (Mo) and a conductive layer including aluminum (Al). For example, it is preferable that the scanning lines G be disposed so that conductive layers including aluminum (Al) contact the main surface 10A. The light reflectance of aluminum (Al) is higher than that of molybdenum (Mo). Thus, the absorption of light diffused through the transparent substrate 10 by the scanning lines G can be suppressed by disposing the scanning lines G so that the conductive layers including aluminum (Al) contact the main surface 10A, as compared to that in a case where the scanning lines G are disposed so that the conductive layers including molybdenum (Mo) of the scanning lines G contact the main surface 10A. The capacitance electrode CPE, the pixel electrodes PE, and the common electrode CE are transparent electrodes formed of a transparent conductive material such as indium tin oxide (ITO) or indium zinc oxide (la)). The semiconductor layers SC are formed of, for example, amorphous silicon. The semiconductor layers SC may be formed of polycrystalline silicon or an oxide semiconductor. The light-shielding layer BM is, for example, a conductive layer having lower resistance than that of the common electrode CE. In an example, the light-shielding layer BM is formed of an untransparent metal material such as molybdenum, aluminum, tungsten, titanium, or silver. The common electrode CE is in contact with the light-shielding layer BM, and thus is electrically connected to the light-shielding layer BM. The resistance of the common electrode CE is thereby lowered. The alignment films AL1 and AL2 are horizontal alignment films having alignment restriction force substantially parallel to the X-Y plane. In an example, the alignment films AL1 and AL2 are subjected to alignment treatment in the first direction X. The alignment treatment may be rubbing treatment or optical alignment treatment. In the example shown in FIG. 4, the display area DA of the display panel PNL is formed to be transparent.

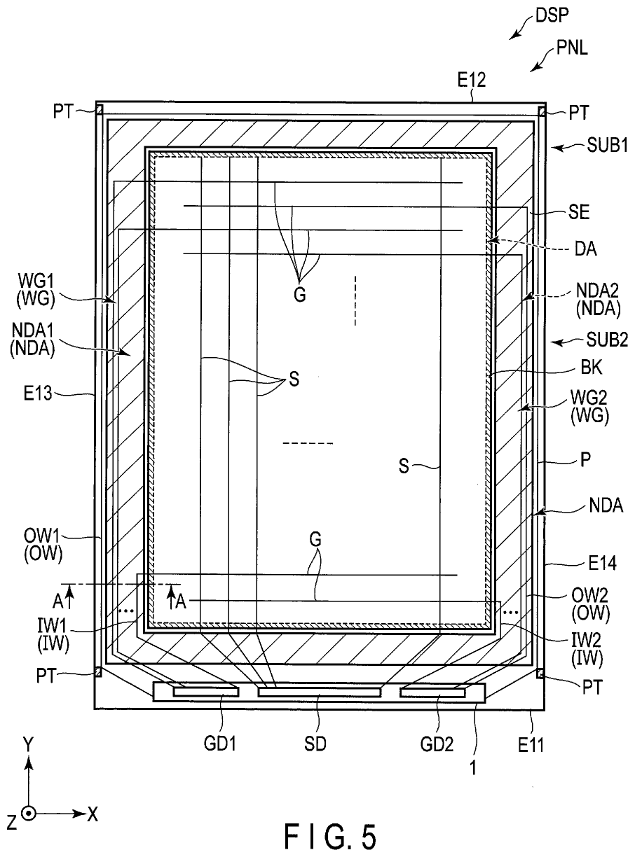

FIG. 5 is a plan view schematically showing a structure example of the first substrate SUB1 according to the present embodiment. FIG. 5 shows only structures necessary for explanation.

In the example shown in FIG. 5, the scanning lines G extend in the first direction X and are arranged at intervals in the second direction Y in the display area DA. The signal lines S extend in the second direction Y and are arranged at intervals in the first direction X in the display area DA. The scanning lines G and the signal lines S are drawn from the display area DA to the non-display area NDA. In the following description, the scanning lines G drawn from the display area DA to the non-display area NDA are also referred to as a line group WG or first lines. The line group WG includes lines extending in the second direction Y and arranged at intervals in the first direction X from a line IW located on the display area DA side (inside) to a line OW located on the edge portion in the non-display area NDA. For example, the length in the second direction Y of the line TW is shorter than the length in the second direction Y of the line OW. The line group WG includes line groups WG1 and WG2. The line group WG1 corresponds to, for example, odd-numbered scanning lines G drawn from the display area DA to a non-display area NDA1 located between the edge portion E13 and the display area DA. The line group WG1 includes lines extending in the second direction Y and arranged at intervals in the first direction X from a line IW1 located inside to a line OW1 located on the edge portion E13 side in the non-display area NDA1. That is, the line IW1 is located at the closest position to the display area DA of the lines included in the line group WG1. The line OW1 is located at the most distant position from the display area DA of the lines included in the line group WG1. The line group WG2 corresponds to, for example, even-numbered scanning lines G drawn from the display area DA to a non-display area NDA2 located between the edge portion E14 and the display area DA. The line group WG2 includes lines extending in the second direction Y and arranged at intervals in the first direction X from a line IW2 located inside to a line OW2 located on the edge portion E14 side in the non-display area NDA2. That is, the line IW2 is located at the closest position to the display area DA of the lines included in the line group WG2. The line OW2 is located at the most distant position from the display area DA of the lines included in the line group WG2.

A power line P is, for example, a line for supplying a common voltage (Vcom). The power line P is electrically connected to the capacitance electrode CPE shown in FIG. 4. In addition, the power line P is connected to feed terminals PT at the corner portions of the first substrate SUB1. The feed terminals PT are electrically connected to the common electrode CE of the second substrate SUB2. That is, the capacitance electrode CPE and the common electrode CE are equal in potential, and for example, a common voltage is applied thereto. In the example shown in FIG. 5, the power line P and the feed terminals PT are located more outside than the line group WG in the non-display area NDA.

The scanning lines G, the signal lines S, and the power line P are electrically connected to the IC chip 1 or the wiring board 2 shown in FIG. 1. In the example shown in FIG. 5, the line group WG1 is electrically connected to a gate driver GD1 provided on the IC chip 1. The line group WG2 is electrically connected to a gate driver GD2 provided on the IC chip 1. The signal lines S are drawn to the non-display area NDA, and are electrically connected to a source driver SD provided on the IC chip 1. The gate driver GD1, the gate driver GD2, and the source driver SD may be provided on the wiring board 2. The gate driver GD1, the gate driver GD2, and the source driver SD may be provided on different IC chips or different wiring boards connected to the extension portion Ex, respectively. The power line P is connected to the IC chip 1.

The sealing material SE is disposed around the display area DA. In the example shown in FIG. 5, the sealing material SE has the shape of a rectangular frame. The sealing material SE may have any shape other than the shape of a rectangular frame, as long as the sealing material SE surrounds the perimeter of the display area DA. The sealing material SE overlaps the line group WG in the non-display area NDA. In the example shown in FIG. 5, the sealing material SE overlaps the entire line group WG1 in the non-display area NDA1, and overlaps the entire line group WG2 in the non-display area NDA2. In other words, the sealing material SE overlaps the line IW1 to the line OW1 in the non-display area NDA1, and overlaps the line IW2 to the line OW2 in the non-display area NDA2. The sealing material SE may be disposed to overlap several inside lines of the line group WG in the non-display area NDA. For example, the sealing material SE may overlap the line IW1 and extend along the line IW1 in the second direction Y in the non-display area NDA1. The sealing material SE may overlap the line IW2 and extend along the line IW2 in the second direction Y in the non-display area NDA2. In addition, the sealing material SE may be located more inside than the line group WG in the non-display area NDA. For example, the sealing material SE may be located more inside in the first direction X than an extension line extending along the line IW1 in the second direction Y in the non-display area NDA1. The sealing material SE may be located more inside in the first direction X than an extension line extending along the line IW2 in the second direction Y in the non-display area NDA2.

When liquid crystals, for example, polymer-dispersed liquid crystals included in the liquid crystal layer LC, are injected into the space between the first substrate SUB1 and the second substrate SUB2 bonded to each other with the sealing material SE by a vacuum injection method, the liquid crystals may adhere to an area on the edge portion side (outside) rather than the sealing material SE in the non-display area NDA. Thus, when liquid crystals are injected into the space between the first substrate SUB1 and the second substrate SUB2 bonded to each other with the sealing material SE by the vacuum injection method, it is preferable that the sealing material SE overlap the entire line group WG in the non-display area NDA. In addition, when liquid crystals are injected into the space between the first substrate SUB1 and the second substrate SUB2 by a drop injection method, the liquid crystals are unlikely to adhere to an area more outside than the sealing material SE in the non-display area NDA. Thus, when liquid crystals are injected into the space between the first substrate SUB1 and the second substrate SUB2 by the drop injection method, the sealing material SE may not overlap several outside lines of the line group WG in the non-display area NDA.

In the example shown in FIG. 5, the sealing material SE is located more inside than the feed terminals PT and the power line P and does not overlap the feed terminals PT and the power line P in the non-display area NDA. In other words, the feed terminals PT and the power line P are located more outside than the sealing material SE in the non-display area NDA. The sealing material SE may overlap the power line P in the non-display area NDA. In addition, the sealing material SE may be located more outside than the power line P in the non-display area NDA. In other words, the power line P may be located more inside than the sealing material SE in the non-display area NDA.

The first substrate SUB1 further comprises a projection BK located more inside than the sealing material SE. In the example shown in FIG. 5, the projection BK is located between the sealing material SE and the display area DA, and is disposed around the display area DA.

In the display device DSP comprising the first substrate SUB1 shown in FIG. 5, since the sealing material SE overlaps the line group WG and the common electrode CE, the liquid crystal layer LC does not overlap the line group WG and the common electrode CE. Thus, in the display device DSP, the driving of the liquid crystal layer LC due to an electric field which can be produced between the line group WG and the common electrode CE can be suppressed. Accordingly, also in a display device in which a light-shielding layer or the like is not disposed in a non-display area NDA and whose entire surface is transparent, the deterioration in display quality due to the driving of a liquid crystal layer LC in the non-display area NDA can be suppressed.

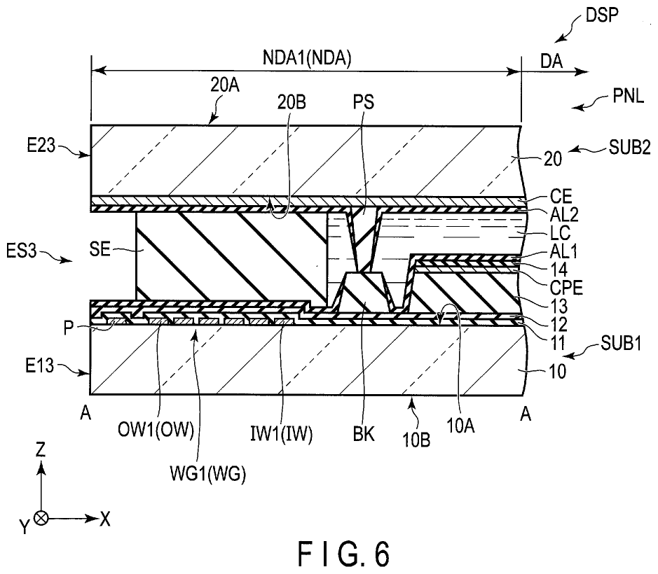

FIG. 6 is a cross-sectional view of the display panel PNL along line A-A shown in FIG. 5. The cross section of the display panel PNL in the non-display area NDA1 shown in FIG. 6 is also applicable to the cross section of the display panel PNL in the non-display area NDA2. FIG. 6 shows only structures necessary for explanation.

The first substrate SUB1 further comprises the power line P, the line group WG1, the projection BK, etc. In the example shown in FIG. 6, the power line P and the line group WG1 are located on the main surface 10A side of the transparent substrate 10, and is covered by the insulating layer 11. In other words, the power line P and the line group WG1 are located between the transparent substrate 10 and the insulating layer 11. That is, the power line P and the line group WG1 are located in the same layer as the gate electrodes GE (scanning lines G). The line group WG1 is located more inside than the power line P in the first direction X. Other insulating layers or various layers may be located between the transparent substrate 10 and each of the power line P and the line group WG1.

Other insulating layers or various layers may be located above the power line P and the line group WG1. In addition, at least one of the insulating layer 11, the insulating layer 12, and the alignment film AL1 may not be provided above the power line P and the line group WG1. The projection BK projects toward the second substrate SUB2. The projection BK is located above the insulating layer 12 in the non-display area NDA1 (NDA). The projection BK is located in the same layer as the insulating layer 13. The projection BK is, for example, formed of the same material as the insulating layer 13. The projection BK is, for example, covered by the alignment film AL1. In other words, the projection BK is located between the insulating layer 12 and the alignment film AL1. The projection BK is located more inside than the line group WG1 in the first direction X. In other words, the projection BK is located between the sealing material SE and the display area DA in the first direction X. Other insulating layers or other various layers may be located below the projection BK. At least one of the insulating layers 11 and 12 may not be provided below the projection BK. In addition, the projection BK may be formed integrally with the insulating layer 13. By disposing the projection BK in this manner, it is possible to suppress the spread of the sealing material SE in the display area DA in the process of bonding the first substrate SUB1 and the second substrate SUB2 to each other with the sealing material SE. In addition, since the projection BK, the insulating layer 13, the insulating layer 14, the capacitance electrode CPE, etc., are not provided, the distance in the third direction Z between the first substrate SUB1 and the second substrate SUB2 outside the projection BK is greater than the distance in the third direction Z between the first substrate SUB1 and the second substrate SUB2 inside the projection BK. By increasing the distance in the third direction Z between the first substrate SUB1 and the second substrate SUB2 in the area where the sealing material SE is disposed in this manner, it is possible to suppress the spread of the sealing material SE in the display area DA in the process of bonding the first substrate SUB1 and the second substrate SUB2 to each other with the sealing material SE.

The second substrate SUB2 further comprises a spacer PS, etc. The spacer PS is located below the common electrode CE. The spacer PS is, for example, covered by the alignment film AL2. In other words, the spacer PS is located between the common electrode CE and the alignment film AL2. The spacer PS projects toward the first substrate SUB1. The spacer PS is opposed to the projection BK. In the example shown in FIG. 6, the tip of the spacer PS is in contact with the projection BK. The spacer PS is located between the sealing material SE and the display area DA in the first direction X. In the example shown in FIG. 6, the common electrode CE is located between the spacer PS and the transparent substrate 20. The common electrode CE overlaps the line group WG (WG1) in an area overlapping the sealing material SE. In addition, the common electrode CE does not overlap the line group WG (WG1) in an area overlapping the liquid crystal layer LC.

The sealing material SE is located between the first substrate SUB1 and the second substrate SUB2. In the example shown in FIG. 6, the sealing material SE is located between the alignment films AL1 and AL2. The sealing material SE is located right above the line group WG1. The sealing material SE is not located right above the power line P. In other words, the sealing material SE is not opposed to the power line P. The sealing material SE may be opposed to the power line P. The sealing material SE is located more inside than the power line P and more outside than the projection BK in the first direction X.

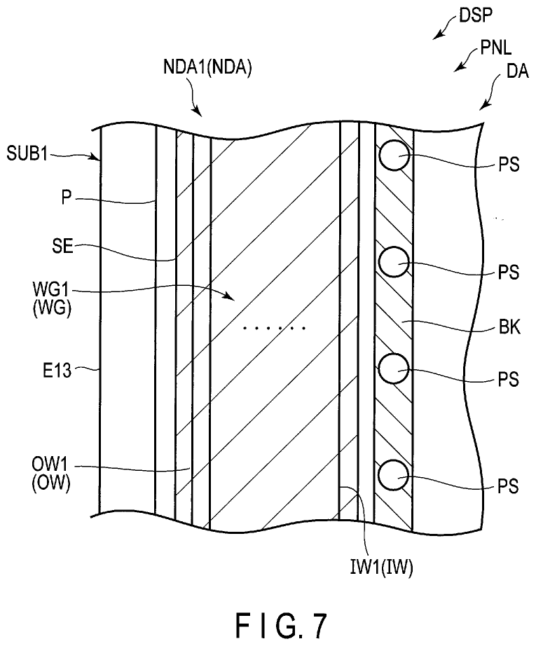

FTG. 7 is a plan view showing a structure example of the display panel PNL shown in FIG. 6. FIG. 7 shows only a structure example of the non-display area NDA1 of the display panel PNL, and the structure example of the non-display area NDA1 is also applicable to the non-display area NDA2. FIG. 7 shows only structures necessary for explanation.

In the example shown in FIG. 7, the spacers PS overlap the projection BK and are arranged at intervals in the second direction Y in the non-display area NDA1.

According to the present embodiment, the display device DSP comprises the first substrate SUB1, the second substrate SUB2 opposed to the first substrate SUB1, and the sealing material SE, with which the first substrate SUB1 and the second substrate SUB2 are bonded to each other. The first substrate SUB1 comprises the line group WG corresponding to the scanning lines G drawn from the display area DA to the non-display area NDA and the projection BK projecting toward the second substrate SUB2 in the non-display area NDA. The sealing material SE overlaps the entire line group WG in the non-display area NDA. Thus, in the display device DSP, it is possible to suppress the driving of the liquid crystal layer LC due to an electric field which can be produced between the line group WG and the common electrode CE in the non-display area NDA. Thus, the deterioration in display quality can be suppressed.

In addition, the projection BK is located more inside than the line group WG in the non-display area NDA. It is therefore possible to suppress the spread of the sealing material SE in the display area DA in the process of bonding the first substrate SUB1 and the second substrate SUB2 to each other with the sealing material SE. Thus, the reliability of the display device DSP can be improved.

Display devices DSP according to another embodiment and a modified example will be next described. In the other embodiment and modified example described hereinafter, the same portions as those of the above-described first embodiment will be given the same reference numerals, and a detailed description thereof will be omitted or simplified. Portions different from those of the first embodiment will be mainly described in detail. Also in the other embodiment and modified example, the same advantages as those of the above-described first embodiment can be obtained.

### Second Embodiment

In a display device DSP according to a second embodiment, the structure of a second substrate SUB2 is different from that in the display device DSP according to the first embodiment.

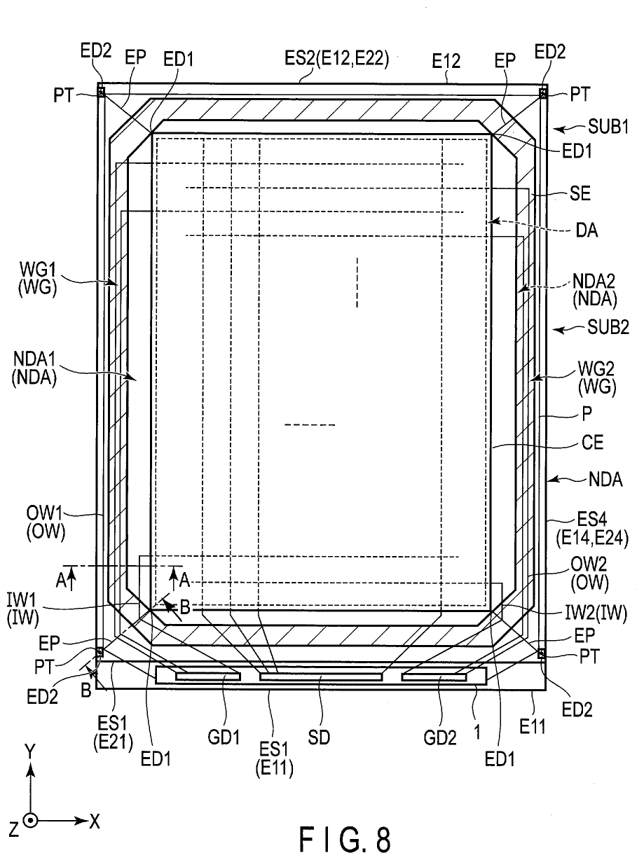

FIG. 8 is a plan view schematically showing the structure of a display panel PNL according to the second embodiment. FIG. 8 shows only structures necessary for explanation.

The second substrate SUB2 comprises a common electrode CE and extension portions EP. The common electrode CE overlaps a display area DA and does not overlap a line group WG. In other words, the common electrode CE is located more inside than a line IW in a first direction X. In the example shown in FIG. 8, the common electrode CE is located more inside than lines IW1 and IW2 in the first direction X. In addition, the common electrode CE is located more inside than a sealing material SE in a second direction Y. The common electrode CE may extend from an edge portion E21 to an edge portion E22 in the second direction Y.

The extension portions EP electrically connect the common electrode CE and a power line P via feed terminals PT. End portions ED1 of the extension portions EP are connected to the common electrode CE, and end portions ED2 of the extension portions EP overlap the feed terminals PT. In the example shown in FIG. 8, the extension portions EP extend from the corner portions of the common electrode CE to areas right above the feed terminals PT. The end portions ED1 are connected to the corner portions of the common electrode CE, and the end portions ED2 overlap the feed terminals PT. The extension portion EP may extend from portions other than the corner portions of the common electrode CE to the areas right above the feed terminals PT. The sealing material SE overlaps at least the end portions ED1. The sealing material SE may overlap the entire extension portions EP. In other words, the sealing material SE may overlap the end portions ED1 to the end portions ED2.

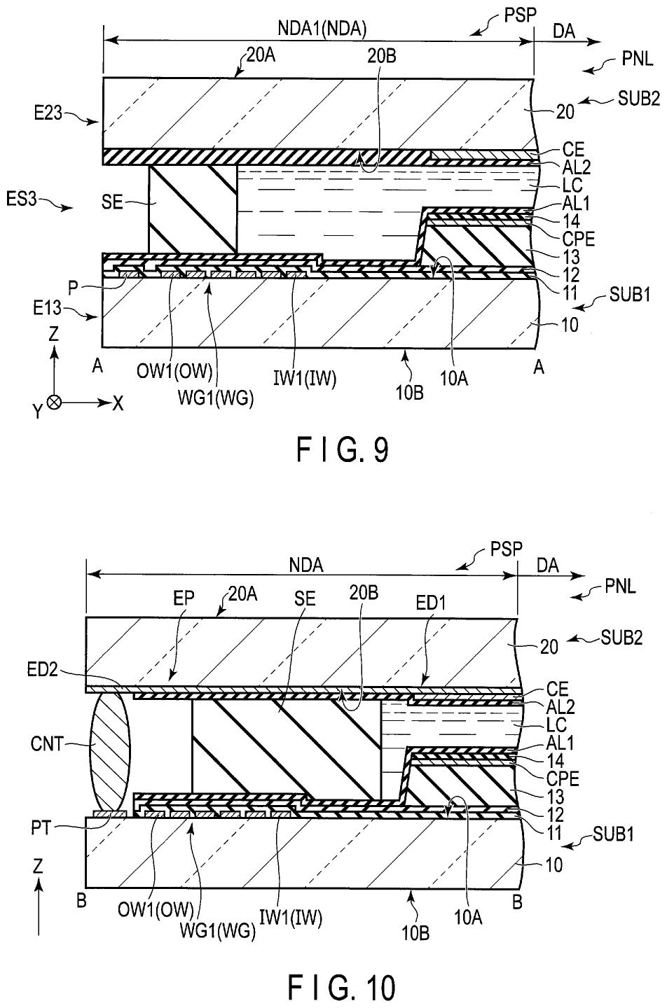

FIG. 9 is a cross-sectional view of the display panel PNL along line A-A shown in FIG. 8. The cross section of the display panel PNL in a non-display area NDA1 shown in FIG. 9 is also applicable to the cross section of the display panel PNL in a non-display area NDA2. FIG. 9 shows only structures necessary for explanation.

The common electrode CE is located more inside than a line group WG1 in the first direction X. In other words, the common electrode CE is inwardly separated from the line group WG1 in the first direction X. In the example shown in FIG. 9, the common electrode CE is located more inside than the line IW1. In other words, the common electrode CE does not extend from the display area DA to an area right above the line IW1. That is, the common electrode CE is not opposed to the line group WG1. In the example shown in FIG. 9, the sealing material SE is opposed to several outside lines of the lines included in the line group WG. For example, the sealing material SE is opposed to a line OW1 and is not opposed to the line IW1. In other words, several lines from the line IW1 to the line OW1 side of the line group WG1 are located between the sealing material SE and the common electrode CE in the first direction X. The sealing material SE may be opposed to the entire line group WG. FIG. 10 is a cross-sectional view of the display panel PNL along line B-B shown in FIG. 8. FIG. 10 shows only structures necessary for explanation.

A first substrate SUB1 further comprises the feed terminal PT, etc. In the example shown in FIG. 10, the feed terminal PT is located on a main surface 10A side of a transparent substrate 10. In other words, the feed terminal PT is located above the transparent substrate 10. The feed terminal PT is located more outside than the sealing material SE. The feed terminal PT is not covered by an insulating layer 11, an insulating layer 12, and an alignment film AL1. The feed terminal PT is, for example, located in the same layer as the power line P and the line group WG1. The feed terminal PT may be located in a layer different from the power line P and the line group WG1. Other insulating layers or various layers may be located between the transparent substrate 10 and the feed terminal PT.

The second substrate SUB2 further comprises the extension portion EP, etc. The extension portion EP is formed of a conductive material. In the example shown in FIG. 10, the extension portion EP is located on an opposite surface 20B side of a transparent substrate 20. In other words, the extension portion EP is located between the transparent substrate 20 and each of an alignment film AL2 and the common electrode CE. For example, the extension portion EP is located in the same layer as a light-shielding layer BM. The extension portion EP may be formed of the same material as the light-shielding layer BM. That is, the extension portion EP may be formed of the light-shielding layer BM. The extension portion EP supplies a common voltage to the common electrode CE. The extension portion EP extends from the common electrode CE to an area right above the feed terminal PT. The end portion ED1 of the extension portion EP is located between the transparent substrate 20 and the common electrode CE, and is in contact with the common electrode CE. The end portion ED2 of the extension portion EP is located right above the feed terminal PT, and is not covered by the alignment film AL2 and the common electrode CE. The extension portion EP overlaps the sealing material SE. The common electrode CE is located more inside than the line group WG1. In other words, the common electrode CE is inwardly separated from the line group WG1. The common electrode CE does not overlap the sealing material SE. The alignment film AL2 covers the common electrode CE and the extension portion EP. The alignment film AL2 does not cover the end portion ED2. Other insulating layers or various layers may be located between the transparent substrate 20 and the extension portion EP. Other insulating layers or various devices may be located between the extension portion EP and each of the alignment film AL2 and the common electrode CE.

In the example shown in FIG. 10, the sealing material SE is opposed to several inside lines of the lines included in the line group WG1. The sealing material SE is opposed to at least the line IW1. The sealing material SE may be opposed to the entire line group WG1. A connection member CNT is located between the first substrate SUB1 and the second substrate SUB2. In the example shown in FIG. 10, the connection member CNT is located more outside than the sealing material SE. The connection member CNT is located between the end portion ED2 of the extension portion EP and the feed terminal PT. The connection member CNT is in contact with the end portion ED2 and the feed terminal PT, and electrically connects the end portion ED2 and the feed terminal PT. The connection member CNT is formed of a conductive material.

According to the second embodiment, the second substrate SUB2 comprises the common electrode CE. The common electrode CE overlaps the display area DA and does not overlap the line group WG. In other words, the common electrode CE is inwardly separated from the line group WG. It is therefore possible to suppress the production of an electric field between the line group WG and the common electrode CE. Accordingly, also in the above-described second embodiment, the same advantages as those of the first embodiment can be obtained.

(Modified example 1) A display device DSP according to a modified example 1 of the first embodiment and the second embodiment has a combined structure of the above-described first and the second embodiments.

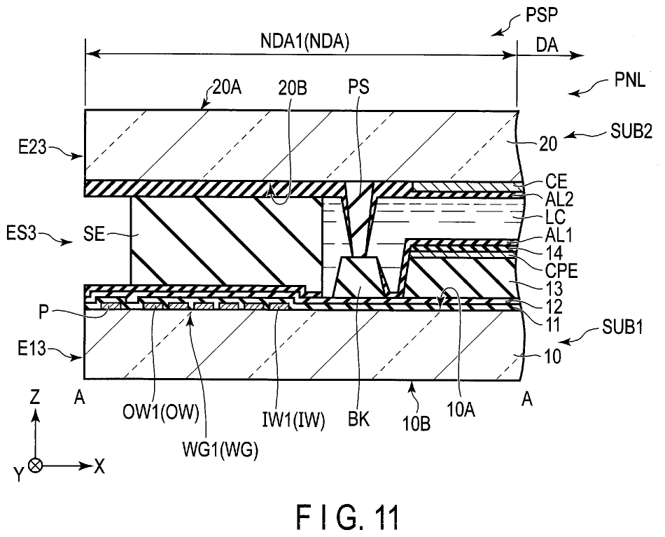

FIG. 11 is a cross-sectional view of the display panel PNL along line A-A shown in FIG. 5 or FIG. 8. The cross section of the display panel PNL in the non-display area NDA1 shown in FIG. 11 is also applicable to the cross section of the display panel PNL in the non-display area NDA2. FIG. 11 shows only structures necessary for explanation. The display device DSP according to the modified example 1 corresponds to a structure example of the combination of the first embodiment and the second embodiment. That is, the display panel PNL shown in FIG. 11 has the structure described hereinafter. The line group WG1 overlaps the sealing material SE. The projection BK and the spacer PS are located opposite to each other inside the sealing material, that is, in an area where the liquid crystal layer LC is located. The projection BK and the spacer PS also can be described as being located between the sealing material SE and the display area DA. The common electrode CE is located over the display area DA and the non-display area NDA in the first direction X. The end portion of the common electrode CE is located between the spacer PS and the display area DA in the first direction X. In other words, the common electrode CE does not overlap the spacer PS. The line group WG1 and the sealing material SE do not overlap the common electrode CE. Also in the display device DSP according to the modified example 1, the same advantages as those of the above-described first and second embodiments can be obtained.

Examples of the display device which can be obtained from the structures disclosed in the present specification are appended below.
(1) A display device comprising:

a first substrate comprising a first transparent substrate comprising a first upper surface and a first lower surface on an opposite side to the first upper surface, and first lines arranged at intervals in a second area around a first area where an image is displayed;

a second substrate comprising a second transparent substrate comprising a second upper surface, a second lower surface opposed to the first upper surface on an opposite side to the second upper surface, and a side surface;

a liquid crystal layer held between the first substrate and the second substrate and including polymers in a shape of stripes and liquid crystal molecules; and a sealing material located in the second area, the first substrate and the second substrate being bonded to each other with the sealing material, wherein the sealing material overlaps the first lines in the second area.

(2) The display device of (1), wherein the first lines are scanning lines.

(3) The display device of (1) or (2), wherein the sealing material extends along the first lines in the second area.

(4) The display device of any one of (1) to (3), wherein the sealing material overlaps the entire first lines in the second area.

(5) The display device of any one of (1) to (4), wherein the second substrate comprises a common electrode overlapping the first lines in the first area and not overlapping the first lines in the second area.

(6) The display device of any one of (1) to (4), wherein the first substrate comprises an organic insulating layer located above a switching element, a capacitance electrode located above the organic insulating layer, and a pixel electrode located above the capacitance electrode, in the first area, and the common electrode is located on the second lower surface side and electrically connected to the capacitance electrode in the first area.

(7) The display device of (5) or (6), wherein the first substrate comprises a power line located more outside than the first lines in the second area, and a terminal located more outside than the first lines in the second area and connected to the power line, and the second substrate comprises a conductive material extending from the common electrode to an area right above the terminal and electrically connecting the common electrode and the terminal.

(8) The display device of any one of (4) to (7), wherein the first substrate comprises a projection located between the sealing material and the first area and projecting toward the second substrate.
(9) The display device of (8), wherein the projection is formed of a same material as the organic insulating layer.

(10) The display device of any one of (1) to (9), further comprising a light-emitting element which is opposed to the side surface and which emits light toward the side surface.

(11) The display device of any one of (1) to (10), further comprising a circuit which outputs a signal for displaying an image, wherein the first lines are connected to the circuit.

(12) A display device comprising:
a first substrate comprising a first transparent substrate comprising a first upper surface and a first lower surface on an opposite side to the first upper surface, and first lines in a second area around a first area where an image is displayed;

a second substrate comprising a second transparent substrate comprising a second upper surface and a second lower surface opposed to the first upper surface on an opposite side to the second upper surface, and a common electrode;

a liquid crystal layer held between the first substrate and the second substrate and including polymers in a shape of stripes and liquid crystal molecules; and a sealing material located in the second area, the first substrate and the second substrate being bonded to each other with the sealing material, wherein the common electrode overlaps the first area and does not overlap the first lines.

(13) The display device of (12), wherein the first lines are scanning lines.

(14) The display device of (12) or (13), wherein the sealing material overlaps the entire first lines in the second area.

(15) The display device of any one of (12) to (14), further comprising a light-emitting element which is opposed to a side surface of the second substrate and which emits light toward the side surface.

(16) The display device of any one of (12) to (15), further comprising a circuit which outputs a signal for displaying an image, wherein the first lines are connected to the circuit.

(17) A display device comprising:
a first substrate comprising a first insulating substrate, a pixel electrode located in a display area, and lines located in the display area and a non-display area surrounding the display area;

a second substrate comprising a second insulating substrate and a common electrode overlapping the pixel electrode;

a liquid crystal layer located between the first substrate and the second substrate; and

a sealing material located in the non-display area, the first substrate and the second substrate being bonded to each other with the sealing material, wherein each of the lines comprises a first portion extending in a first direction in the display area and a second portion extending in a second direction crossing the first direction in the non-display area, the lines include first lines whose second portions overlap the sealing material, and the common electrode does not overlap the second portions in an area overlapping the liquid crystal layer.

(18) A display device comprising a display area where an image is displayed and a non-display area surrounding the display area, the display device comprising:

a first substrate comprising a first transparent substrate and lines located in the display area and the non-display area;

a second substrate comprising a second transparent substrate and a common electrode located in at least the display area;

a liquid crystal layer located between the first substrate and the second substrate and including polymers in a shape of stripes and liquid crystal molecules;

a sealing material located in the non-display area, the first substrate and the second substrate being bonded to each other with the sealing material;

and a light-emitting element opposed to a side surface of the second transparent substrate and emitting light toward the side surface, wherein each of the lines comprises a first portion extending in a first direction in the display area and a second portion extending in a second direction crossing the first direction in the non-display area, the lines include first lines whose second portions overlap the sealing material, and the common electrode does not overlap the second portions in an area overlapping the liquid crystal layer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate comprising a first insulating substrate, a pixel electrode located in a display area, and lines located in the display area and a non-display area surrounding the display area;
a second substrate comprising a second insulating substrate and a common electrode overlapping the pixel electrode;
a liquid crystal layer located between the first substrate and the second substrate; and
a sealing material located in the non-display area, the first substrate and the second substrate being bonded to each other with the sealing material,
wherein each of the lines comprises a first portion extending in a first direction in the display area and a second portion extending in a second direction crossing the first direction in the non-display area,
the lines include first lines, the second portion of each of the first lines overlapping the sealing material, and
the common electrode does not overlap the second portion in an area overlapping the liquid crystal layer.

2. The display device of claim 1, wherein the common electrode overlaps the second portion in an area overlapping the sealing material.

3. The display device of claim 1, wherein the lines include second lines, the second portion of each of the second lines overlapping the liquid crystal layer, and
the second portion of each of the second lines overlapping is located between the sealing material and the common electrode in the first direction.

4. The display device of claim 1, wherein the first substrate comprises a projection located between the sealing material and the display area in the first direction and projecting toward the second substrate.

5. The display device of claim 4, wherein the second portion is located at an opposite side to the display area with respect to the projection in the first direction.

6. The display device of claim 4, wherein the second substrate comprises a spacer projecting toward the first substrate and opposed to the projection.

7. The display device of claim 6, wherein the common electrode is located between the spacer and the second insulating substrate.

8. The display device of claim 6, wherein the common electrode does not overlap the spacer.

9. The display device of claim 1, wherein the common electrode extends to an opposite side to the display area with respect to the sealing material.

10. The display device of claim 1, wherein the second substrate comprises an extension portion formed of a conductive material and connected to the common electrode,
the common electrode does not overlap the sealing material, and
the extension portion overlaps the sealing material and is connected to a terminal at an opposite side to the common electrode with respect to the sealing material.

11. The display device of claim 10, wherein the extension portion supplies a common voltage to the common electrode.

12. The display device of claim 1, wherein the first insulating substrate and the second insulating substrate are transparent substrates.

13. The display device of claim 1, wherein the liquid crystal layer includes polymers in a shape of stripes and liquid crystal molecules.

14. The display device of claim 1, wherein the lines are scanning lines.

15. The display device of claim 1, further comprising a light-emitting element which is opposed to a side surface of the second insulating substrate and which emits light toward the side surface.

16. The display device of claim 1, wherein the display area is transparent.

17. A display device comprising:
a display area configured to display an image;
a non-display area surrounding the display area;
a first substrate with a first transparent substrate and lines located in the display area and the non-display area;
a second substrate with a second transparent substrate and a common electrode located in at least the display area;
a liquid crystal layer located between the first substrate and the second substrate and including polymers in a shape of stripes and liquid crystal molecules;
a sealing material located in the non-display area, the first substrate and the second substrate being bonded to each other with the sealing material; and
a light-emitting element opposed to a side surface of the second transparent substrate and emitting light toward the side surface,
wherein each of the lines includes a first portion extending in a first direction in the display area and a second portion extending in a second direction crossing the first direction in the non-display area,
the lines include first lines, the second portion of each of the first lines overlapping the sealing material, and
the common electrode does not overlap the second portion in an area overlapping the liquid crystal layer.

18. The display device of claim 17, wherein the common electrode overlaps the second portion of each of the first lines in an area overlapping the sealing material.

19. The display device of claim 17, wherein the lines include second lines, the second portion of each of the second lines overlapping the liquid crystal layer, and
the second portion of each of the second lines overlapping is located between the sealing material and the common electrode in the first direction.

20. The display device of claim 17, wherein the display area is transparent when the image is not displayed in the display area.
